(19) United States
(12) Patent Application Publication
(10) Pub. No.: US 2015/0167764 A1
(43) Pub. Date: Jun. 18, 2015

(54) FRICTION MATERIAL ENGAGEMENT OF A FRICTION MEMBER

(71) Applicant: Akebono Brake Industry Co., Ltd, Tokyo (JP)

(72) Inventor: Aurelian Eric Bahmata, South Lyon, MI (US)

(21) Appl. No.: 14/531,197

(22) Filed: Nov. 3, 2014

Related U.S. Application Data
(60) Provisional application No. 61/915,644, filed on Dec. 13, 2013.

(51) Int. Cl. F16D 65/12; F16D 65/04

(52) U.S. Cl. CPC F16D 65/127; F16D 65/04

(57) ABSTRACT

A pressure member comprising: (a) (a) a pressure plate and (b) friction material comprising: (i) a plurality of angled ridges that each include: (1) a top; (2) a bottom; and (3) a friction surface extending at an angle between the top and the bottom; wherein during a brake apply the pressure member is moved by an apply force and a normal force is generated by each of the plurality of angled ridges that extends at an angle relative to the apply force and wherein the normal force is greater than the apply force.

### FIELD

The present teachings relate to a brake pad and/or brake shoe having friction material with an improved shape that provides increased braking performance and a rotor and/or drum with an improved shape that provides increased braking performance.

### BACKGROUND

The present teachings are predicated upon providing a friction material shape for use in a brake system (e.g., a disc brake system, a drum brake system, a park brake system, an electric park brake system, or a combination of both) for use with vehicles. For example, the brake system may be used with almost any vehicle (e.g. car, truck, bus, train, airplane, or the like). Alternatively, the brake system may be integrated into assemblies used for manufacturing or other equipment that require a brake such as a lathe, winder for paper products or cloth, amusement park rides, wind turbines, or the like. However, the present teachings are most suitable for use with a passenger vehicle (e.g., a car, truck, sports utility vehicle, or the like).

Generally, a braking system includes a rotor, a caliper body, a support bracket, an inboard brake pad, and an outboard brake pad that are on opposing sides of the rotor. Typically, the inboard brake pad, the outboard brake pad, and the rotor each include planar friction surfaces so that when the brake pads are in contact with the rotor a friction force is generated. The caliper body further includes one or more fingers, one or more piston bores, and a bridge that connects the one or more fingers to the piston bore or two opposing piston bores together. The piston bore houses a piston. The piston bore has a bore axis that the piston moves along during a brake apply and a brake retraction The piston bore may include a fluid inlet, a closed wall, a front opening, and a cylindrical side wall that includes a seal groove located near the front opening. Typically, the fluid inlet is located in the closed wall of the piston bore so that when pressure is applied the fluid will flow into the piston bore. During a pressure apply the fluid will push the piston towards the front opening and into contact with a brake pad that generally includes a pressure plate and friction material with a planar surface, and the friction material will contact a planar surface of the rotor on one side and an opposing brake pad will contact the planar surface of the rotor on an opposing side creating friction to stop rotation of the rotor and any component connected to the brake system.

Another type of braking system includes two brake shoes in the hat of the rotor and/or drum so that when a braking force and/or parking brake force is desired the brake shoes are moved into contact with an inner surface of the hat of the rotor (e.g., a drum-in-hat brake system) and/or drum (drum brake system). Typically, brake shoes pivot on one end and have a link on an opposing end that separates the brake shoes so that the brake shoes are moved into contact with an opposing surface to generate a friction force. The link is connected to a pressure plate on each of the brake shoes so that friction material exposed on the pressure plates directly contacts a surface of the drum and/or hat to generate a friction force.

Examples of braking systems and associated brake pads and/or brake shoes are disclosed in U.S. Pat. Nos. 3,285,372; 3,425,519; 5,377,802; and 6,491,138; and U.S. Patent Application Publication No. 200410178027; 2012/0067691; and 2013/0020154 all of which are expressly incorporated herein by reference for all purposes. What is needed is a braking system with an improved brake pad and/or brake shoe that increases the friction force between the brake pad and/or brake shoe and a complementary braking surface by amplifying the applied force, so that improved braking is generated. What is needed is an improved rotor and/or drum that increases friction force from a brake pad and/or brake shoe respectively by amplifying the applied force, so that improved braking is generated. It would be attractive to have a brake system with improved braking capabilities without increasing the force generated against the brake pads and/or brake shoes without increasing the pressure applied by a piston, a link, a cable or a combination thereof.

### SUMMARY

One possible embodiment of the present teachings include: a pressure member comprising: (a) a pressure plate and (b) friction material comprising: (i) a plurality of angled ridges that each include: (1) a top; (2) a bottom; and (3) a friction surface extending at an angle between the top and the bottom; wherein during a brake apply the pressure member is moved by an apply force and a normal force is generated by each of the plurality of angled ridges that extends at an angle relative to the apply force and wherein the normal force is greater than the apply force.

One possible embodiment of the present teachings include: a rotational member comprising: (a) two or more circumferential grooves including: (i) a peak; (ii) a valley; and (iii) a contact surface extending at an angle between the peak and valley; wherein during a brake apply the angle of the contact surface creates a normal force that extends at an angle relative to an apply force; and wherein the normal force is greater than the apply force.

Another possible embodiment of the present teachings include: a brake assembly comprising: (a) two or more pressure members each comprising: (i) a pressure plate and (ii) friction material in communication with the pressure plate, the friction material comprising: (1) a plurality of angled ridges that each including: (a) a top; (b) a bottom; and (c) a friction surface extending at an angle between the top and the bottom; (b) a rotational member comprising: (i) a plurality of circumferential grooves each including: (1) a peak; (2) a valley; and (3) one or more contact surfaces extending at an angle between the peak and valley; wherein during a brake apply the pressure member is moved by an apply force that towards the rotational member so that the friction surface of the pressure member contacts the contact surfaces of the rotational member generating a normal force that extends at an angle relative to the apply force; and wherein the normal force is greater than the apply force.

The present teachings provide a braking system with an mproved brake pad and/or brake shoe that increases the friction force between the brake pad and/or brake shoe and a complementary braking surface by amplifying the applied force, so that improved braking is generated. The present teachings provide an improved rotor and/or drum that increases friction force from a brake pad and/or brake shoe respectively by amplifying the applied force, so that improved braking is generated. The present teachings provide a brake system with improved braking capabilities without increasing the force generated against the brake pads and/or brake shoes without increasing the pressure applied by a piston a link, a cable, or a combination thereof.

### BRIEF DESCRIPTION OF THE DRAWINGS

FIG. 1 illustrates a perspective view a rotor in contact with a pair of brake pads with the caliper removed;

FIG. 2 illustrates a perspective view of a rotor nd a brake pad side by side with the surfaces of each exposed;

FIG. 3 illustrates a top view of the rotor and brake pad of FIG. 2;

FIG. 4 illustrates a cross-sectional view of the rotor and brake pads of FIG. 1 cut along lines 4-4;

FIG. 5 illustrates a perspective view of a pair of brake shoes in the hat of a rotor;

FIG. 6 illustrates the rotor and brake shoes of FIG. 5 cut along line 6-6;

FIG. 7 illustrates an exploded view of FIG. 5;

FIG. 8 illustrates a close-up view of a contact area of the brake shoe and rotor of FIG. 6;

FIG. 9A illustrates an example of an angled ridge;

FIG. 9B illustrates an example of an angled ridge;

FIG. 9C illustrates an example of an angled ridge;

FIG. 9D illustrated an example of an angled ridge:

FIG. 10 illustrates the forces generated from an example of an angled ridge during a brake apply;

FIG. 11 illustrates an angled ridge having an arcuate friction surface; and

FIG. 12 illustrates a cross-sectional view of an angled ridge extending into a circumferential groove.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings claim priority from U.S. Patent Application Publication No. 61/915,644, filed on Dec. 13, 2013, the contents of which are incorporated by reference herein in its entirety for all purposes. The teachings herein relate to one or more improved friction members that work in unison to provide improved braking performance. The one or more friction members may be two or more complementary friction members that are moved into contact to form a brake apply. The one or more friction members may be a brake pad, a brake shoe, a rotor, a drum, a hat of a rotor, or a combination thereof. The one or more friction members when installed in a system preferably include one or more rotational members and one or more pressure members that are complementary to each other so that a friction force is created. The rotational members may be a rotor, a drum, a hat of a rotor, or a combination thereof The pressure members may be a brake pad, a brake shoe, or both. The one or more friction members may be installed in a brake system. The brake system may be a disc brake system, a drum brake system, a drum-in-hat brake system, a parking brake system, an electric parking brake system, or a combination thereof.

A disc brake system as discussed herein may include a rotor, a caliper, a support bracket, two or more brake pads, one or more rotational members, one or more pressure members, or a combination thereof. The disc brake system may be free of a support bracket. Preferably, the disc brake system includes a support bracket. The support bracket may function to connect the disc brake system to the vehicle, a knuckle, an assembly or a combination thereof; support the brake pads in the brake system; extends around a rotor; extend around two or more brake pads; or a combination thereof. The support bracket may include an abutment that the brake pads axially extend along. The support bracket may connect to pins that the brake pads move along The support bracket may connect to a knuckle and a caliper may be connected to the support bracket.

The caliper may function to assist in creating a brake apply. The caliper may function to move during a brake apply so that a braking force is created. The caliper may be a floating caliper, a fixed caliper, or both. The caliper may be used with or without a support bracket. The caliper may include one or more pistons, two or more pistons, one or more opposing pistons, two or more opposing pistons, four or more opposing pistons, or a combination thereof. The caliper may include one or more pistons on one side and one or more fingers on an opposing side and during a brake apply the piston may extend at least partially out of a piston bore into contact with a brake pad so that the brake pad is moved into contact with a first side of a rotor and the fingers may be moved into contact with an opposing brake pad so that the opposing brake pad is moved into contact with a second side of the rotor. In another example, two opposing pistons may simultaneously move towards each other and into contact with brake pads and then opposing sides of a rotor so that a brake apply is formed. The one or more pistons may extend out of the caliper along a piston bore axis and move the brake pads along the piston bore axis into contact with a rotational member.

The rotational member may be a rotor, a hat of a rotor, a drum, or a combination thereof. The rotational member may be a member that moves and when contacted by a pressure member creates a friction force so that braking is created. The rotational member may function to be a member that rotates with movement and the rotation is reduced through friction to stop a device such as a vehicle. The rotational member when it is a rotor may function to assists in producing a brake force during contact with one or more brake pads. The teachings herein for the rotor may be applied to the drum and vice versa. The rotor may be generally circular and rotate about an axis of rotation. The rotor may have a hat and two opposing braking surfaces and the hat and two opposing brake surfaces may all be used to create a friction force. The hat may include a braking surface on an inside (e.g, a drum-in-hat rotor), The drum may be a hat of a rotor, a discrete drum, or both. The drum may function as a cylinder that houses one or more brake shoes that radially expand to contact an inner surface of the hat and/or drum to create a friction force. The drum may be cylindrically shaped and include one or more contact surfaces on an inside of the drum. The drum may include a plurality of circumferential grooves that extend around an inside circumference of the drum. The plurality of circumferential grooves may be included in the rotor, on a surface of the rotor, or both. Thus, for example, the teachings regarding the circumferential grooves having peaks, valleys, and contact surfaces as is discussed herein may be the same for the drum as they are for the rotor and vice versa. Preferably the drum and/or hat may be configured to receive and contact brake shoes whereas the surfaces of the rotor outside the hat are configured to receive and contact brake pads. The two opposing braking surfaces of a rotor may each be contacted by a brake pad during a brake apply, and the hat and/or drum may include a braking surface that is contacted by brake shoes. The braking surfaces may include one or more circumferential grooves, preferably two or more circumferential grooves, three or more circumferential grooves, or even four or more circumferential grooves.

The circumferential grooves may be any feature that extends from the braking surfaces, may be any feature that is formed into the braking surfaces, or both of a rotational ember (e.g., rotor and/or drum). The circumferential grooves may function to improve braking performance; increase braking pressure generated by a brake system, without increasing pressure of the piston and/or link; form a complementary fit to a feature of a pressure member (e.g., brake pad and/or brake shoe); or a combination thereof. Each of the one or more circumferential grooves may include a peak and a valley with a contact surface extending therebetween.

The peaks and valleys may extend to any height so that the circumferential grooves function to increase a force generated during a brake apply (when compared to flat friction surfaces) when the circumferential grooves are contacted by an opposing braking surface (e.g., brake pad and/or brake shoe). The peak may contact an opposing bottom, the valley may be contacted by an opposing top, the peak may be free of contact with a bottom, the valley may be free of contact with a top, an open space may be present between a peak and a bottom, an open space may be present between a valley and a top, or a combination thereof. The peaks and valleys may extend to a point, be “V” shaped, be “U” shaped, be flat, be arcuate, taper, have a blunt end, have a flat surface, or a combination thereof. The shape of the peaks and valleys may be substantially the same when the rotational members are in a new state, a worn state, or a state therebetween. The contact surfaces extending between the peak and valley may be straight, arcuate, concave, convex, include one or more bends that form an arc, one or more bends that change an angle of the contact surfaces, may be complementary to an angled ridge of a brake pad and/or brake shoe, or a combination thereof. The contact surfaces may extend at an angle between the peaks and valleys (e.g., an angle relative to a pressure plate or a surface supporting the friction material). The angle of the contact surfaces may extend at any angle so that the contact surfaces function to increase braking performance, increase a force generated during a brake apply, or both. The angle of the contact surface may form an angle from a vertical plane, a direction of an apply force, or both. The angle of the contact surface from the vertical plane, the direction of the apply force, or both may be about 75 degrees or less, about 45 degrees or less, preferably about 30 degrees or less, more preferably about 15 degrees or less, even more preferably about 10 degrees or less, or most preferably about 5 degrees or less. The rotor may include a primary peak, a primary valley, or both.

The primary peak, the primary valley, or both may generally form a point, may taper, may have a blunt end, may have a flat surface, may form a “V” shape, may form a “U” shape, or a combination thereof. A primary peak may function to extend into a central region of a brake pad and/or brake shoe; to separate one or more angled ridges of a brake pad and/or brake shoe; to extend outward so that only some of the angled ridges of the brake pad and or brake shoe are contacted in a new condition, a worn condition, or a condition therebetween; or a combination thereof. A primary peak may be larger than some of the surrounding peaks so that when the rotor, the brake pads, the brake shoes, or a combination thereof are new and/or worn the primary peak prevents the brake pads and/or brake shoes from contacting a valley of the rotor. A primary peak may be located in a central region of the rotor, may extend above the adjacent peaks, or both. A primary valley may function to extend into the rotational member to define surrounding peaks. A primary valley may have deeper recess then adjacent valleys. A primary valley, a primary peak, or both may form a majority (i.e., 40 percent or more, 50 percent or more, or even 60 percent or more) of the surface area of contact with a pressure member. The primary valley may be located in a central region of the rotational member, may extend below adjacent valleys, or both. Preferably, when a primary peak is present a primary valley is not present or vice versa. More preferably, when a primary peak is present every other angled ridge of a pressure member is contacted (e.g. the outer friction surfaces are contacted and the inner friction surfaces are not contacted).

The teachings herein provide one or more pressure members. The one or more pressure members may function to create a braking force. The pressure members may function to move from a running state to an apply state so that a friction force is created. The pressure members may include one or more connection features (e.g., pressure plate, a dip connected to a pressure plate, shim, spacer, or a combination thereof) for connecting to a brake system, sliding within a brake system, or both. The one or more pressure members may also be a friction member. Preferably, the pressure members may be a brake pad, a brake shoe, or both. More preferably, each pressure member may include a pressure plate and a friction material,

The pressure plate may function to connect to a friction material so that a braking farce may be created, the pressure plate may connect the pressure member to a brake system, the pressure member may move the friction material so that a braking force is generated, or a combination thereof. The pressure plate may provide support for the friction material; provide a point of contact with other brake components, a point for moving the brake pad to create a brake apply, or a combination thereof. The pressure plate may be made of any material so that the pressure plate provides support to friction material, assists in producing a friction force during braking, or both. The pressure plate may be made of metal, a formable material, a stampable material, a composite material, a material with sufficient rigidity to provide support to a friction material during a braking event, or a combination thereof. The pressure plate may have a complementary shape to the friction material, the pressure plate may be flat, arcuate, have a flat surface and be generally arcuate, include one or more recesses for receiving a connector, include one or more recesses for receiving friction material, or a combination thereof. The pressure plate may include one or more connection features so that the pressure plate may be included in a brake system.

The friction material may function to assist in creating a braking force. The friction material may function to be a point of contact between the pressure member and a rotational member. The friction material may be asbestos free, copper free, or both. The friction material may include basalt fibers. The friction material may be compressed materials that are connected to a pressure plate. The friction material may be applied to the pressure plate using any method and/or material. The connection between the friction material and the pressure plate may be a mechanical connection (e.g., a rivet, a projection, a bolt, a fastener, peened, the like, or a combination thereof), a chemical connection (e.g., adhesive, epoxy, bonding agent, the like, or a combination thereof), or a combination of both. The friction material may include one or more angled ridges and preferably a plurality of angled ridges.

The angled ridges may be any feature that extends from the friction material, may be any feature that is formed into the friction material, or both of a pressure member. The angled ridges may function to improve braking performance; increase braking pressure generated by a brake system, without increasing pressure of the piston and/or link; form a complementary fit to a feature of a rotor and/or drum; or a combination thereof. Each of the one or more circumferential grooves may include a top and a bottom with a friction surface extending therebetween.

The tops and bottoms may extend to any height so that the angled ridges function to increase a force generated during a brake apply when the angled ridges are contacted by an opposing contact surface (e.g., rotor and/or drum). The top may contact an opposing valley, the valley may be contacted by an opposing top, the peak may be free of contact with a bottom, the valley may be free of contact with a top, an open space may be present between a peak and a bottom, an open space may be present between a valley and a top, or a combination thereof. The tops and bottoms may extend to a point, be “V” shaped, be “U” shaped, be flat, be arcuate, taper, have a blunt end, have a flat surface, or a combination thereof. The shape of the tops and bottoms may be substantially the same when the pressure members are in a new state, a worn state, or a state therebetween. The tops may be shapes similarly to a corresponding valley andior peak and the bottoms may be shaped similarly to a corresponding peak and/or valley as taught herein. The friction surfaces extending between the top and bottom may be straight, arcuate, concave, convex, include one or more bends that form an arc, one or more bends that change an angle of the friction surfaces, may be complementary to an circumferential grooves of a rotor and/or drum, or a combination thereof. The friction surfaces may extend at an angle between the tops and bottoms. The angle of the friction surfaces may extend at any angle so that the friction surfaces function to increase braking performance, increase a force generated during, a brake apply, or both. The angle of the friction surface may form an angle from a vertical plane, a direction of an apply force, or both. The angle of the contact surface from the vertical plane, a direction of an apply force, or both may be about 75 degrees or less, about 45 degrees or less, preferably about 30 degrees or less, more preferably about 15 degrees or less, even more preferably about 10 degrees or less, or most preferably about 5 degrees or less. The pressure members may include a primary top, a primary bottom, or both.

The primary top, the primary bottom, or both may generally form a point, may taper, may have a blunt end, may have a flat surface, may form a “V” shape, may form a “U” shape, or a combination thereof. A primary top may function to extend into a central region of a rotational member; to separate one or more circumferential grooves of a rotational member; to extend outward so that only some of the circumferential grooves of the rotational members are contacted in a new condition, a worn condition, or both; or a combination thereof. A primary top may be larger than some of the surrounding peaks so that when the rotor, the brake pads, the brake shoes, or a combination thereof are new and/or worn the primary top prevents the drum and/or rotor from contacting a bottom of the pressure members. A primary top may be located in a central region of the pressure member, may extend above the adjacent tops, or both. A primary bottom may function to extend into the pressure members to define surrounding peaks. A primary bottom may have a deeper recess then adjacent bottoms. A primary bottom and/or primary bottom may farm a majority (i.e., 40 percent or more, 50 percent or more. or even 60 percent or more) of the surface area of contact with a rotational member. The primary bottom may be located in a central region of the pressure member, may extend below adjacent bottoms, or both. Preferably, when a primary top is present a primary bottom is not present, or vice versa. More preferably, when a primary top is present every other circumferential groove of the pressure member is contacted (e.g. the outer contact surfaces are contacted and the inner contact surfaces are not contacted). More preferably, the pressure members include a primary bottom and the rotational member includes a primary peak so that the contact surfaces and the friction surfaces are aligned and contacted during a brake apply.

The contact surfaces, the friction surfaces, or both may function to contact each other and create a friction force. The contact surfaces, the friction surfaces, or bath may be complementary to each other so that the contact surfaces inter fit between the friction surfaces and vice versa. The contact surfaces and the friction surfaces may both be flat, both me concave, both be convex, one may be convex and one may be concave, be generally parallel with each other, having a nesting connection, a mating connection, have a connection so that as one or both surfaces wear the surface area and shape remain substantially intact, or a combination thereof. The contact surfaces, the friction surfaces, or both may have the same configuration whether formed in a rotor and/or a drum or a brake pad and/or a brake shoe respectively. The contact surfaces may be angled so that an apply force may be amplified.

The apply force may be a force along the axis of the piston bore, perpendicular to a pressure plate, through a height for thickness) of the friction material, through one or more shims, through one or more spacers, or a combination thereof when viewed in the cross-section. The direction of the apply force may a line that extends through the axis of the hat and/or drum and is perpendicular to a cylindrical side wall, a cylindrical Gaussian surface, or both, a line extending radially outward from the axis of a hat and/or drum, or a combination thereof. The direction of the apply force may be perpendicular to a plane along a face of the rotor that includes the circumferential grooves when viewed in the cross-section. The direction of the apply force may lie along a vertical plane when measuring an angle of a contact surface, a friction surface, or both. Preferably, the direction of the apply force extends along the vertical plane as discussed herein for the angled ridges, the circumferential grooves, or both. During a brake apply, the apply force may move the brake pad and/or brake shoe into contact with an opposing surface and the angle of the friction surfaces may generate a side force and a normal force.

The side force extends at a right angle relative to the apply force. The side force may also be referred to as a horizontal force. The side force may be equal to or greater than the apply force. The side force may extend from each side of a circumferential groove, an angled ridge, or both so that the side forces on opposing sides of a circumferential groove offset each other. The angle of the side force relative to a vertical plane, the apply force direction, or both may vary based upon the angle of the contact surface, the friction surfaces, or both. The side force may always be 90 degrees from the apply force and a normal force may be half way between the side force and the apply force.

The normal force may be normal to the contact surface, the friction surface, or both. The normal force may be greater than the side force, the apply force, or both. Preferably, the normal force is greater than the side force and the apply force. The normal force may be greater than the side force, the apply force, or both by a factor of about 1.1× or more, about 1.2× or more, about 1.3× or more, or even about 1.4× or more. The normal force may be greater than the side force, the apply force, or both by a factor of 5× or less, about 4× or less, or about 3× or less. The magnitude of the normal force may vary based upon the angle of the contact surface, the friction surface, or both from vertical. For example, the normal force of a contact surface that is 15 degrees from the vertical plane will be less than a contact surface that is 10 degrees from the vertical plane. The normal force extends at a right angle from the contact surface and the friction surface. The normal force may extend at an angle of about 90 degrees or less, about 60 degrees or less, or about 45 degrees or less from the side force, the apply force, or both. The normal force may extend at an angle of about 10 degrees or more, about 15 degrees or more, about 25 degrees or more, or about 30 degrees or more from the side force, the apply force, or both. The angle of the friction surface, the contact surface, or both is varied the angle between the normal force and the side force and the apply force will vary.

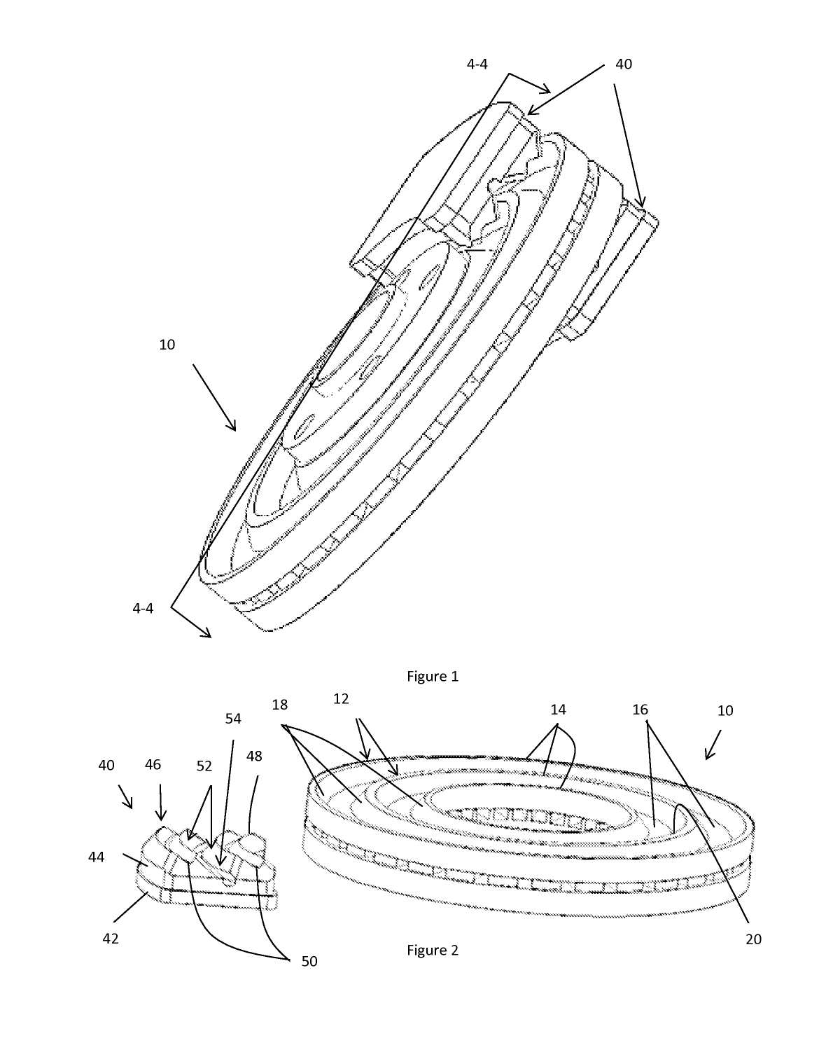

FIG. 1 illustrates a perspective view of a pair of brake pads 40 in contact with a rotor 10.

FIG. 2 a perspective view of a brake pad 40 next to a rotor 10 so that a surface of the brake pad 40 and a surface of a rotor 10 are exposed. The brake pad 40 includes a pressure plate 42 and a friction material 44. The friction material 44 incudes a plurality of angled ridges 46. The angled ridges 46 have a plurality of tops 48 and a plurality of bottoms 50. Friction surfaces 52 are located on each side of the angled ridges 46 so that the friction surfaces 52 extend from a top 48 to a bottom 50. The friction surfaces 52 include a primary bottom 54 that separates two tops 48 so that two tops 48 are located on each side of the primary bottom 54. The primary bottom 54 receives a primary peak 20 of a rotor 10 so that two tops 48 of the brake pad 40 extend on each side of the primary bottom 54. The rotor 10 further includes a plurality of circumferential grooves 12 that include a plurality of peaks 14 and valleys 16. One of the plurality of circumferential grooves 12 includes a primary peak 20. Each of the circumferential grooves 12 include a contact surface 18 that extends between the peak 14 and valley 16 so that during a brake apply the contact surface 18 of the rotor contacts the friction surfaces 52 of the brake pad 40 creating a friction force.

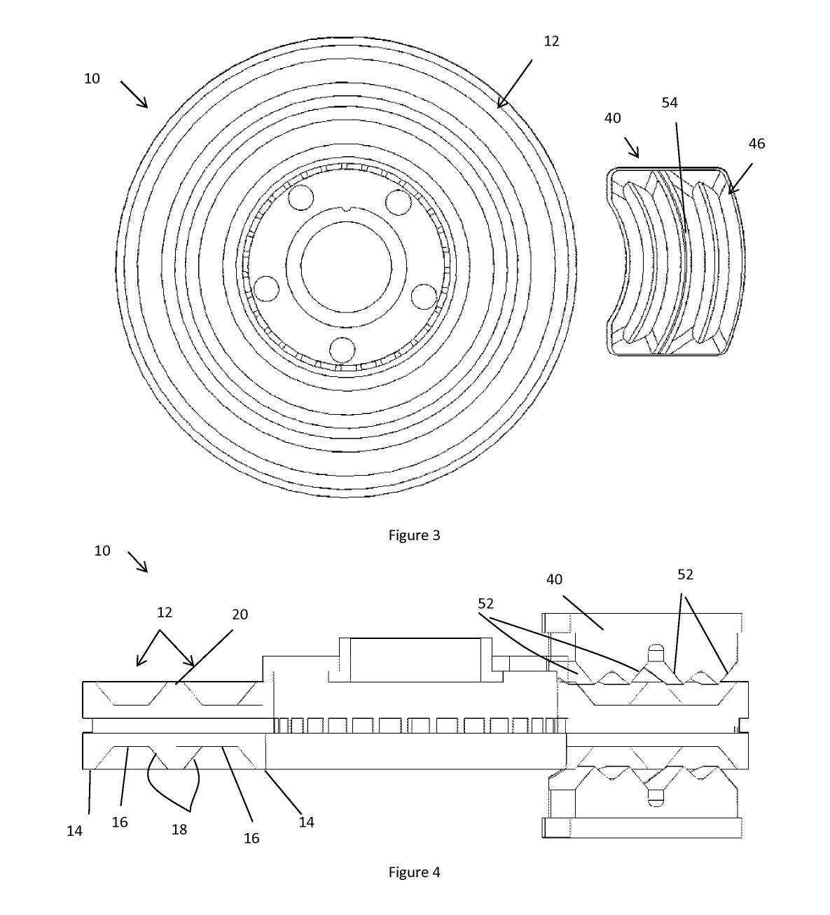

FIG. 3 illustrates a top view of the rotor 10 and a brake pad 40. As illustrated the circumferential grooves 12 of the rotor 10 and the angled ridges 46 of the brake pad 40 are shown. The primary bottom 54 of the brake pad 40 is shown extending down a center of the brake pad 40.

FIG. 4 illustrates a cross-sectional view of FIG. 1 along lines 4-4. The rotor 10 includes a plurality of circumferential grooves 12. The circumferential grooves 12 include peaks 14 and valleys 16 with a primary peak 20 in the center of the circumferential grooves 12. Contact surfaces 18 extend between each peak 14 and each valley 16 so that during a brake apply the contact surfaces 18 contact a friction surface 52 of a brake pad 40 to create a friction force.

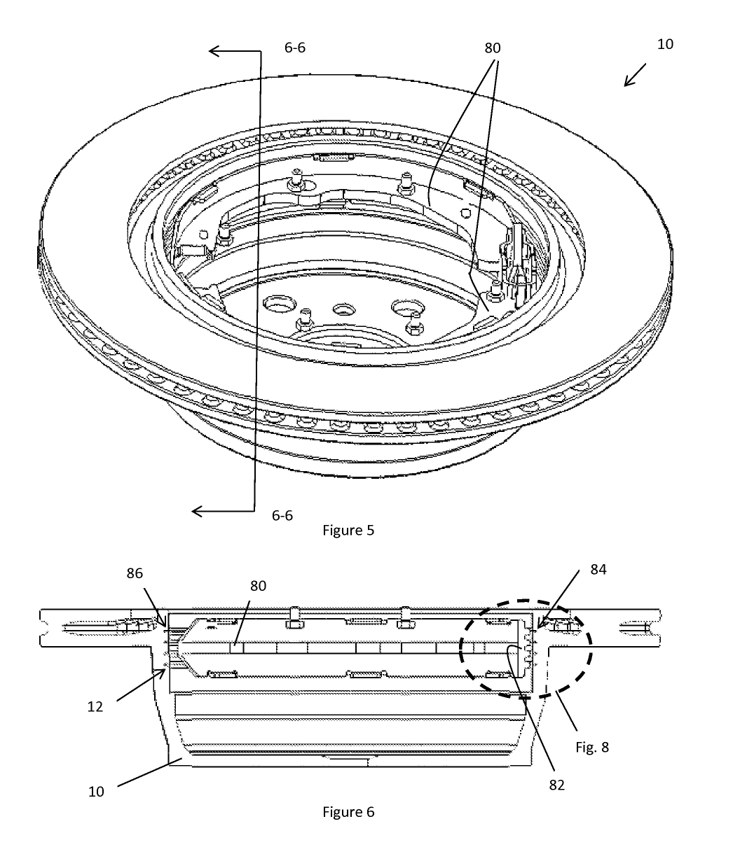

FIG. 5 illustrates a perspective view of a rotor 10 that serves as a drum and houses brake shoes 80.

FIG. 6 illustrates a cross-sectional view of the rotor 10 and brake shoes 80 along lines 6-6. The rotor 10 includes a plurality of circumferential grooves 12 that align with angled ridges 86 of the brake shoes 80. The brake shoes 80 include a pressure plate 82 and friction material 84.

FIG. 7 illustrates an exploded view of the rotor 10 and brake shoes 80. The pressure plate 82 and friction material 84 of the brake shoe 80 are exposed so that the angled ridges 86 of the pressure plate 82 and the corresponding circumferentialgrooves 2 of he rotor are shown.

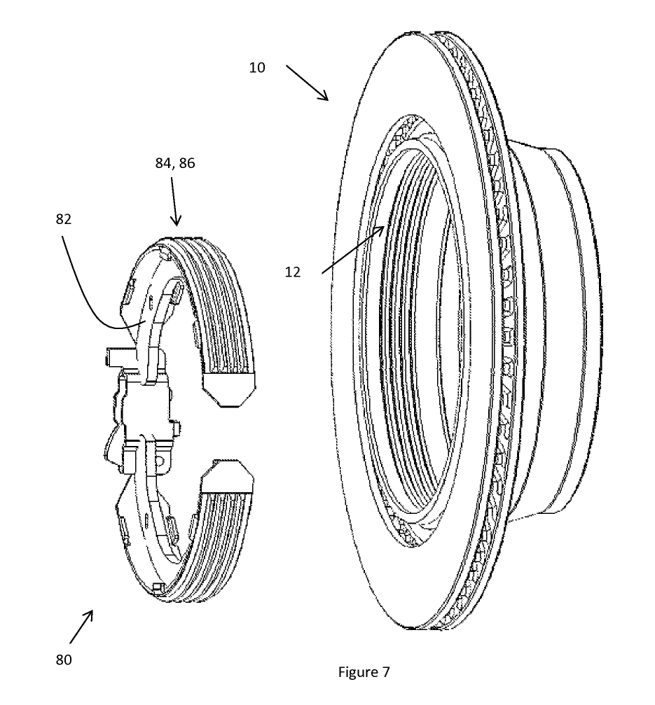

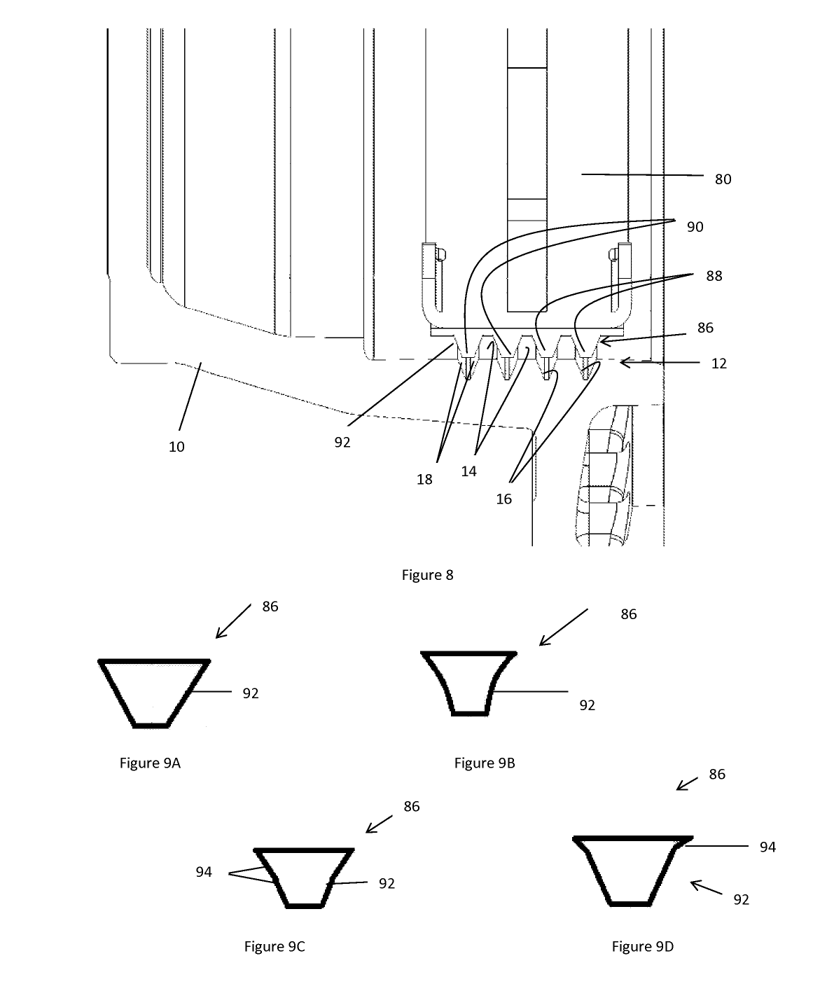

FIG. 8 illustrates a dose up view of the rotor 10 and brake shoes 80 of FIG. 6. As illustrated, the plurality of circumferential grooves 12 is located in the rotor 10. Each circumferential groove 12 includes a peak 14 and a valley 16 with a contact surface 18 extending therebetween. Each circumferential groove 12 corresponds with an angled ridge 86 of the brake shoe 80. Each circumferential ridge 86 includes a top 88 and a bottom 90 with a friction surface 92 extending therebetween.

FIGS. 9A-9D illustrates various configurations of the friction surfaces 92 of the angled ridges 86. FIG. 9A illustrates a friction surface 92 with a generally flat configuration. FIG. 9B illustrates a friction surface 92 with an arcuate configuration. FIG. 9C illustrates a friction surface 92 with a plurality of bends 94 that curve so that the friction surface 92 has flat surfaces with a generally arcuate configuration. FIG. 9D illustrates a friction surface 92 with a bend 94 on one end so that the friction surface 92 changes contour at the bend 94.

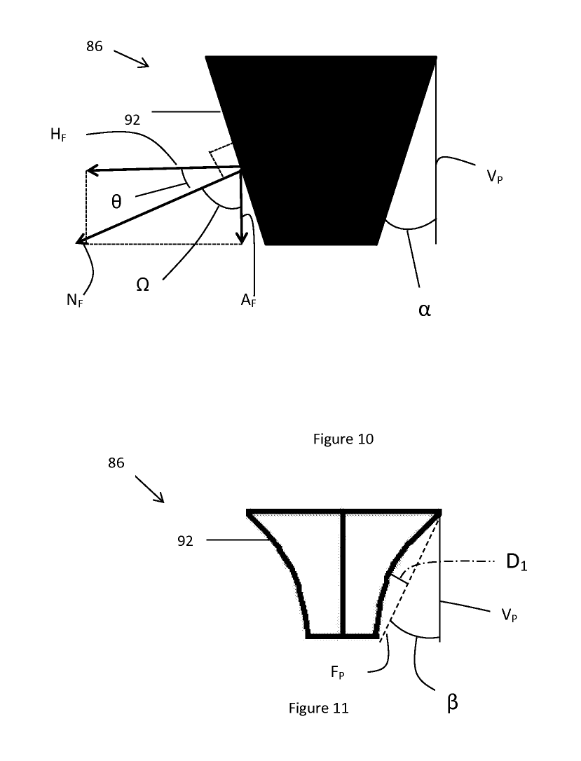

FIG. 10 illustrates a close up view of the angled ridge 86 of FIG. 9A. The friction surfaces 92 form an angle (α) with a vertical plane (V_{P}). During a brake apply, the friction surfaces 92 are moved by an apply force (A_{F}) so that as the fiction surfaces 92 of the angled ridges 86 generate a side force (S_{F}) and a normal force (N_{F}) upon contact with an opposing component. The normal force (N_{F}) is at a right angle to the friction surface and increases the apply force (A_{F}) so that braking is improved when compared to a force in the apply direction only. The angle (α) may vary so that the angle (Ω) between the apply force (A_{F}) and the normal force (N_{F}) changes and the angle (α) between the normal force (N_{F}) and side force (S_{F}) are varied so that the normal force (N_{F}) can be increased or decreased.

FIG. 11 illustrates an angled ridge 86 that includes a pair of opposing friction surfaces 92. The friction surfaces 92 are generally arcuate. The face of the friction surfaces 92 forms an arc having a distance (D₁) from a flat plane (F_{P}). The flat plane (F_{P}) extends at an angle (β) from a vertical plane (V_{P}).

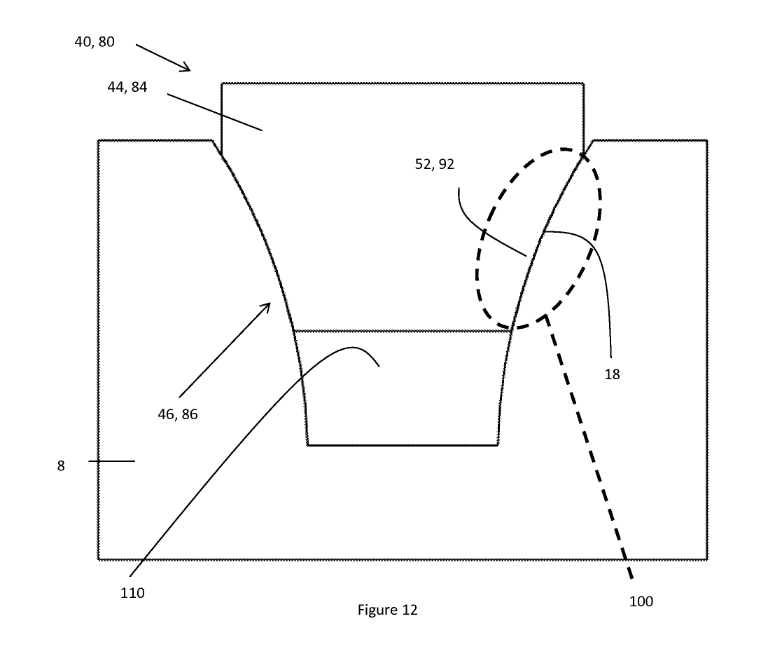

FIG. 12 illustrates the friction material 44, 84 of the pressure member 40, 80 in contact with a rotational member 8. The rotational member 8 includes a contact surface 18 that during a brake apply contacts a friction surface 52 of the friction material 44 in a contact area 100 with an open space 110 existing between an end of the friction member 40, 80 and the rotational member 8.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements ingredients, components or steps.

I claim:

1. A pressure member comprising:
(a) a pressure plate and
(b) friction material comprising:
(i) a plurality of angled ridges that ach include:
(1) a top;
(2) a bottom: and
(3) a friction surface extending at an angle between the top and the bottom;
wherein during a brake apply the pressure member is moved by an apply force and a normal force is generated by each of the plurality of angled ridges that extends at an angle relative to the apply force and
wherein the normal force is greater than the apply force.

2. The pressure member of claim 1, wherein each of the friction surfaces lie straight between the top and the bottom, forming a straight line in a cross-sectional view.

3. The pressure member of claim 1, wherein each of the friction surfaces follow a curve between the top and the bottom forming an arc in a cross-sectional view.

4. The pressure member of claim 1, wherein the friction surfaces include one or more bends so that an angle of the friction surfaces changes along a length of the friction surfaces.

5. The pressure member of claim 1, wherein the friction surfaces extend at an angle of about 5 degrees or more from a vertical plane.

6. The pressure member of claim 2, wherein the friction surfaces extend substantially at an angle of about 60 degrees or less from a vertical plane.

7. The pressure member of claim 3, wherein the arc in a cross-section is concave.

8. The pressure member of claim 1, wherein the normal force extends at substantially a right angle with the friction surface.

9. The pressure member of claim 1, wherein the plurality of angled ridges are at least four angled ridges and the at least four angled ridges are equally divided so that an equal number of ridges are on each side of a primary bottom.

10. The pre ember of claim 1, wherein each of the angled ridges have n identical shape.

11. The pressure member of claim 1, wherein some of the plurality of angled ridges have a different shape.

12. The pressure member of claim 1, wherein the pressure member is a brake pad.

13. A rotational member comprising;
a. two or more circumferential grooves including:
i. a peak;
ii. a valley; and
iii. a contact surface extending at an angle between the peak and valley;
wherein during a brake apply the angle of the contact surface creates a normal force that extends at an angle relative to an apply force; and
wherein the normal force is greater than the apply force.

14. The rotational member of claim 13, wherein the rotational member includes a hat and circumferential friction surface connected to the hat.

15. The rotational member of claim 14, wherein the hat includes the two or more circumferential grooves.

16. The rotational member of claim 14, wherein the circumferential friction surface includes the two or more circumferential grooves.

17. The rotational member of claim 14, wherein the circumferential grooves include a primary peak that is located in a central portion of the circumferential grooves.

18. A brake assembly comprising:
a. two or more pressure members each comprising:
i. a pressure plate and
ii. friction material in communication with the pressure plate, the friction material comprising:
1. a plurality of angled ridges that each including:
a. a top:
b. a bottom; and
c. a friction surface extending at an angle between the top and the bottom;
b. a rotational member comprising:
i. a plurality of circumferential grooves each including:
1. a peak;
2. a valley; and
3. one or more contact surfaces extending at an angle between the peak and valley;
wherein during a brake apply the pressure member is moved by an apply force th towards the rotational member so that the friction surface of the pressure member contacts the contact surfaces of the rotational member generating a normal force that extends at an angle relative to the apply force; and
wherein the normal force is greater ttarl the apply force.

19. The brake assembly of claim 18, wherein the angle of the friction surface and the angle of the contact surface are substantially the same.

20. The brake assembly of claim 18, wherein the angle of the friction surfaces are about 25 degrees or less from a vertical plane.
